(19) United States
(12) Patent Application Publication
(10) Pub. No.: US 2024/0336391 A1
(43) Pub. Date: Oct. 10, 2024

(54) Moulded Fiber Container for Dairy Products, Method for Manufacturing Such Container and Use Thereof

(71) Applicant: Huhtamaki Molded Fiber Technology B.V., Leeuwarden (NL)

(72) Inventors: Harald John Kuiper, Leeuwarden (NL); Vincent Biencourt, Leeuwarden (NL)

(21) Appl. No.: 18/579,136

(22) PCT Filed: Jul. 16, 2021
(86) PCT No.: PCT/NL2021/050451

§ 371 Date: Jan. 12, 2024

(51) Int. Cl. B65D 1/26; B65D 25/14; B65D 65/46; B65D 85/80; D21J 1/08; D21J 3/10

(52) U.S. Cl. CPC B65D 1/265; B65D 25/14; B65D 65/466; B65D 85/80; D21J 1/08; D21J 3/10

(57) ABSTRACT

The present invention relates to a moulded fiber container for dairy products, method for manufacturing such container and use thereof. The moulded fiber container according to the invention comprises: —a cup-like container body configured for holding an amount of a dairy product, and having a bottom part and wall part; —a flange configured for attaching a sealing lid thereon for closing the cup-like container body; wherein the cup-like container body and the flange are a moulded fiber product, wherein the inner surface of cup-like container body is provided with an inner barrier-coating, and wherein the outer surface of cup-like container body is provided with an outer barrier-coating and/or in-mould paper label.

The present invention relates to a moulded fiber container for dairy products, such as yoghurt, milk, and other products. Such container is used to contain, store, transport and/or display the dairy product. The container includes cups, bowls, and other carriers suitable for these products.

Containers for dairy products are often mainly made of plastic, like polypropylene, and cardboard with a liner from polyethylene on the inside of the packaging unit. Problems with these containers relate to recycling, (home) compostability and availability of raw material for the container.

The present invention has for its object to obviate or at least reduce one or more of the above stated problems with conventional containers for dairy products and to provide a container that is more sustainable and/or has improved recycling possibilities.

For this purpose, the present invention provides a moulded fiber container for dairy products, the container comprising:
a cup-like container body configured for holding an amount of a dairy product, and having a bottom part and wall part;
a flange configured for attaching a sealing lid thereon for closing the cup-like container body;
wherein the cup-like container body and the flange are a moulded fiber product,
wherein the inner surface of cup-like container body is provided with an inner barrier-coating, and
wherein the outer surface of cup-like container body is provided with an outer barrier-coating and/or in-mould paper label.

Dairy products should withstand relatively severe temperature conditions in a range of 2° C. to 8° C. and also freezing conditions of −18° C., depending on the specific product type. In experiments, the use of the moulded fiber product, with an inner coating and an outer coating and/or in-mould paper label on the outside surface of the container, has shown to be able to withstand these conditions and to keep its structural integrity such that a shelf-life of 45 to 55 days can be guaranteed. Especially the use of a so-called smooth moulded fiber product for the container enables the use of the moulded fiber material for the container according to the present invention.

The inner coating protects the dairy product and provides a water vapour barrier to protect the product against outside conditions, such as a relatively high humidity of up to 90% and above during (cold) storage and transport of these containers.

The outer coating and/or in-mould paper label on the outside container surface protects the moulded fiber product from condensation, or at least the effects of condensation on the outside of the container when the container is transported from chilled or freezing conditions to outside environments, for example. This occurs when a consumer takes the product home from a supermarket, for example. This outer coating and/or label protects the integrity and stability of the moulded fiber product and thereby extends its shelf-life. An advantage of the in-mould paper label applied onto the outside container surface is the enhanced possibility for decoration purposes in combination with the added functionality of water vapour resistance by providing a (thin) varnish coating on the outside of the in-mould label. These labels avoid water vapor penetration and protect the pots/containers getting soggy and/or getting less stiff under chilled conditions

The cup-like container body is at its upper edge provided with a flange that is configured for attaching a seal or lid thereon for closing the body.

The container body and the flange are a moulded fiber product and comprise an amount of plant-based fiber material in a (pulp) matrix comprising wood and/or non-wood fiber material, with wood material comprising soft wood (long fibers) and/or hard wood (short fibers) and/or so-called kraft fibers, wherein the fibers are preferably refined. The fiber material can be of recycled origin to provide an alternative material source to the use of so-called virgin fibers. The container is preferably biodegradable and more preferably compostable.

In the context of this invention, degradable relates to degradation resulting in loss of properties, while biodegradable relates to degradation resulting from the action of microorganisms such as bacteria, fungi and algae. Compostable relates to degradation by biological process to yield carbon dioxide (CO₂), water, inorganic compounds and biomass. Preferably, the container is home compostable (e.g. according to EN 13432:2000, EN 14046:2004 in Europe and AS 5810 “biodegradable plastics suitable for home composting” in Australia).

The moulded fiber container is preferably provided with a sealing lid to protect the dairy product in the container. In one of the presently preferred embodiments of such sealing lid a paper layer is provided with a coating similar to the inner and/or outer coating. The sealing lid is connected to the flange of the moulded fiber product. In some of the embodiments the sealing lid connects to the fibers in the flange, especially in case an amount of biodegradable aliphatic polyesters this included. In alternative embodiments a small amount of thin release polymer connects the flange and the sealing lid.

According to the invention a seal or lid is provided, which is preferably also biodegradable and preferably compostable. This seal or lid is configured for covering the cup-like container body.

The seal or lid is attached to the flange of the container. The seal is preferably manufactured from a biodegradable, or even compostable, material and may involve the use of biodegradable aliphatic polyesters, optionally in combination with a paper layer.

The seal or lid can be adhered to the flange, thereby effectively providing a strong bonding to the fiber material in the matrix of the moulded fiber product. It is believed that this provides a strong bonding such that the adherence of the seal to the flange is effective. Experiments have shown that separate glue or glue material is not needed and is preferably omitted, thereby contributing to the overall sustainability of the container according to the invention. Surprisingly, the strong bonding of the seal or lid to the flange is sufficient. The bonding can be further improved by providing the flange that extends outwardly from the wall part of the container body with one or more compressed areas. By providing the flange with a compressed area or areas the rigidity and stability of the flange is significantly improved. This provides a more stable surface area for attaching thereto the seal or lid such that the sealing properties of the container are improved. This also further reduces the need for the application of glue or glue material to attach the seal to the container. It will be understood that this contributes to the overall sustainability of the container. The compressed area may extend over substantially the entire flange or may alternatively comprise a number of local areas that are preferably distributed over the entire flange surface.

In a presently preferred embodiment the inner and/or outer coating is a silicon-based coating.

Providing a silicon-based coating provides a thin layer of coating material to the moulded fiber product. In a presently preferred embodiment this silicon-based coating comprises a silicon oxide and/or silane. The advantage of applying this type of coatings is that these coatings form a flexible layer on the surface of the (“smooth”) moulded fiber product. It is believed that these coatings penetrate to some extent into the fiber material of the flange and assure a good adherence thereto. The seal integrity of the combination of coating layer, or lidding film, and container makes it possible to take the containers from the shelf and transport it, without risk for leakage and risk for breaking the barrier. The use of these coating types assures that the coating maintains in position and provides the water-vapour barrier during the entire life of the container. The silicon-based coating can be provided on the inner and/or outer surface of the cup-like container body. Optionally, also the flange is provided with the coating.

In a further preferred embodiment the inner and/or outer barrier-coating comprises an amount of graphene, chitosan, alginate, wax, polyethylene, silica gel.

Experiments showed that these coatings provide a reliable and sufficient barrier, especially to transfer of water and water vapour, thereby protecting the dairy product in the container. In addition, the use of these coatings further protects the moulded fiber product and maintains its stability and integrity. These coatings can be provided on the inner and/or outer surface of the cup-like container body. Optionally, also the flange is provided with the coating. Also, it is possible to provide the different coatings in a coating mixture and apply the mixture to the inner and/or outer surface of the cup-like container body. Furthermore, it is possible to provide different coatings on the inner and outer surface of the cup-like container body, and optionally the flange. This provides even more flexibility to providing a coating in accordance to the specific circumstances and/or product type.

In a presently preferred embodiment of the invention the matrix of the moulded fiber product further comprises an amount of microfibrillated cellulose (MFC). In the context of the present invention this may also include nanofibrillar cellulose or cellulose nanofibers or nanocellulose. MFC preferably originates from cellulose raw material of plant origin. The use of MFC enhances the fiber-fiber bond strength and further improves the reinforcement effect in the matrix.

According to such embodiment of the invention MFC provides improved barrier properties. MFC may fill the gaps between the fibers and, therefore, has gas barrier properties, for instance an enhanced oxygen barrier. When MFC is modified, e.g. the carboxyl groups are replaced by a hydrophobic group, the modified MFC can enhance also the water vapor barrier. As a further advantage, a paper look and/or paper feel surface layer can be provided or improved. This paper look and/or paper feel surface layer contributes to the consumer's appreciation of the container according to the invention. Tests have additionally shown a good wet strength and the aforementioned barrier properties. Barrier properties may include oxygen and/or grease and/or moisture barriers. It is believed that the oxygen barrier properties are achieved by the ability of MFC to form a dense network involving intramolecular bonds and/or intermolecular bonds. For example, intramolecular bonds such as covalent bonds and/or intermolecular bonds such as hydrogen bonds and/or covalent bonds and/or Van der Waals interaction and/or ionic bonds. Preferably, said dense network comprises hydrogen bonds. Also, as mentioned earlier, the relatively small MFC particles fill the gaps between the fibers in the fiber matrix and therefore enhances the (gas) barrier properties further.

Optionally, some hydrophobic elements, such as alkanes, oils, fats, and greasy substances and/or other suitable hydrophobic elements, are added to an MFC layer to further improve the water barrier properties. This may involve modification of the hydroxyl groups, for example on the surface of the micro fibrils chemically and/or by absorption of polymers, for example.

A further advantage of the use of MFC is the improved printability, including digital printing possibilities, especially when combined with one or more additional fillers, such as calcium carbonate and/or calcium bicarbonate and/or clay. A further effect of the use of MFC is the tendency to (slightly) roughen the surface (Bendtsen roughness). In addition or as an alternative, MFC may reduce cost by reducing the weight or grammage by increasing the amount of fillers.

This may also enhance the visual appearance of the container.

Preferably, the amount of microfibrillated cellulose is in the range of 1.2 wt % to 10 wt % of the moulded fiber product, preferably in the range of 1.8 wt % to 5 wt %, and most preferably in the range of 2 wt % to 4.2 wt %. Besides desired barrier properties, experiments showed an improved container performance, for example an increased tensile strength of the container.

In one of the preferred embodiments of the invention the container comprises an amount of a biodegradable aliphatic polyester.

The biodegradable aliphatic polyester may relate to poly (butylene succinate) also referred to as PBS, polybutylene sebacate terephthalate also referred to as PBST, polyhdroxyalkanoate also referred to as PHA, for example including polyhdroxybutyraat also referred to as PHB and/or poly (3-hydroxybutyrate-co-3-hdroxyhexanoate) also referred to as PHBH and/or poly (3-hydroxybutyrate-co-3-hydrovalerate) also referred to as PHBV, polycaprolactone also referred to as PCL, poly (lactic acid) also referred to as PLA, poly (glycolic acid) also referred to as PGA, polybutyleneadipate-terphthalate also referred to as PBAT and also known with its commercial name ecoflex, and/or other suitable components, such as poly (alkylene dicarboxylate) other than PBS, PBAT and PBST, poly (lactic-co-glycolic acid) also referred to as PLGA, including mixtures or blends. It is noted that for example PBAT and PBST comprise an aromatic part and aliphatic part. Therefore, PBAT and PBST may also be referred to as biodegradable aliphatic-aromatic polyester (or biodegradable aromatic polyester) and are, therefore, included in the group of biodegradable aliphatic polyesters. An example of a blend is a blend of PBAT and PLA, also known with its commercial name Ecovio, or a blend of PBAT and PBS, or another suitable blend that is preferably home compostable. In some of the presently preferred embodiments of the invention the biodegradable aliphatic polyester is bio-based. This further improves the sustainability of the packaging unit of the invention.

The presence of the biodegradable aliphatic polyester in the matrix of the moulded fiber product contributes to the reduction of swelling of the packaging unit.

In one of the embodiment of the invention the amount of biodegradable aliphatic polyester in the moulded fiber matrix is in the range of 0.5 wt % to 20 wt % of the cup-like container body, preferably in the range of 1 wt % to 16 wt %, more preferably in the range of 1 wt % to 15 wt %, even more preferably in the range of 2 wt % to 10 wt %, even more preferably in the range of 5 wt % to 9 wt %, and most preferably in the range of 6.5 wt % to 8 wt %.

In a further embodiment of the invention the amount of biodegradable aliphatic polyester in the moulded fiber matrix is in the range of 0.1 wt % to 12 wt % of the cup-like container body, preferably in the range of 0.5 wt % to 8 wt %, more preferably in the range of 1 wt % to 5 wt %, and most preferably in the range of 2 wt % to 4 wt %.

By applying an amount of biodegradable aliphatic polyester in one of the aforementioned ranges, the sustainability and packaging characteristics of the containers according to the present invention are significantly improved. Applying an amount of biodegradable aliphatic polyester in these ranges provides containers that are both stable and strong, and further improve the denesting properties of the containers. Another advantage when using biodegradable aliphatic polyester in a container is the constancy of size or dimensional stability.

In an embodiment of the invention the biodegradable aliphatic polyester in the moulded fiber matrix comprises fibers that preferably have a length of above 1.2 mm. Providing fibers of the biodegradable aliphatic polyester achieves a network of moulded and biodegradable aliphatic polyester fibers in the moulded fiber matrix. This further improves the strength of the packaging unit. In addition, it may further improve barrier properties.

In a further embodiment of the invention the fibers comprise PBS and/or PBST and/or PBAT. Experiments have shown that the PBS fibers effectively melt into the matrix and form a strong network. This is also possible with PBST and/or PBAT fibers. It is noted that for example PBAT and PBST comprise an aromatic part and aliphatic part. Therefore, PBAT and PBST may also be referred to as biodegradable aliphatic-aromatic polyester (or biodegradable aromatic polyester) and are, therefore, included in the group of biodegradable aliphatic polyesters.

It will be understood that combinations of MFC and/or biodegradable aliphatic polyesters may further improve the mentioned effects and advantages. As a further example, a combination of biodegradable aliphatic polyester, such as PBS, PBAT, PBST with cellulose fibers significantly reduces the swelling of the packaging material. These cellulose fibers may be a mixture of short fiber hard wood pulp (e.g. birch) and long fiber soft wood pulp. In a presently preferred embodiment the long cellulose fibers have an average length of about 2 mm to 3 mm, and preferably about 2.5 mm, the short fibers have an average length of about 0.5 mm to 1.2 mm, and preferably about 0.9 mm.

Combinations of MFC and/or biodegradable aliphatic polyesters in the matrix of the moulded fiber product enhance the oxygen barrier of the container. This enables preserving the quality of the products. By having such barrier in the matrix of the moulded fiber product itself, the requirements for the thickness of the (bio) film are achievable with simplified barrier-film and/or barrier-coating constructions at reduced thickness. In the application of the container lactic acid bacteria are facultative anaerobic, meaning they prefer a bit of oxygen. Preferably, an Oxygen Transfer Rate (OTR) of the biofilm construction applied to the pots/containers is above 100 ml O₂/m2·day) to allow oxygen penetration into the pots/containers. Such combination also provides a water vapour transfer barrier. In addition, such mixture may enhance stiffness, strength, and furthermore reduce the weight of required container. This may improve manufacturing speed because the same strength and stiffness can be achieved by lower weight products, that additionally may also reduce the energy requirements for the drying step as well as heating temperature.

The use of MFC and/or biodegradable aliphatic polyesters in the matrix of the moulded fiber product further improves the sealing possibilities of the flange. More specifically, the connection of the seal or lid to the flange is significantly improves. This further improves the possibilities to omit the use of an additional glue or glue material and, therefor, contributes to improving the sustainability of the container for dairy products.

The matrix of the moulded fiber product of the container according to the present invention further comprises an amount of wet strength agent. Applicable wet strength agents (or resins) include Xelorex additives (or BIM DS2801 DS2802 etc dry strength agents). Xelorex showed in experiments that it may provide a functional additive for a container according to the present invention. The wet strength agent improves the release of the container from the mould in the manufacturing process of the container.

In a presently preferred embodiment the amount of wet strength agent is in the range of 0 wt % to 3 wt % of the cup-like container body, more preferably in the range of 1 wt % to 2.5 wt %. This wt % relates to the supplied additive. The active component in this mostly water based dispersion is, therefore, typically in the range of about 0.15 wt % to about 0.5 wt %. Further wt % of wet strength agents will be presented in relation to the supplied additive.

The combination of MFC, biodegradable aliphatic polyester and wet strength agent provides the desired product properties that enable the use of the container.

In a further preferred embodiment of the invention the matrix of the moulded fiber product further comprises an amount of calcium carbonate and/or calcium bicarbonate.

Providing an amount of calcium carbonate and/or calcium bicarbonate provides a smoother surface to the product receiving body. The calcium (bi) carbonate, or alternatively the clay (filler), provides such smoother surface because the filler is filling the gaps between the fibers and smoothens the surface and enhances printability/decoration and improves denesting because less rough fibers at the surface tend to hook into each other. In addition, it further reduces fiber swelling and penetration of compounds of the product into the matrix and/or fibers. Furthermore, dewatering is improved. This enables higher machine speeds in manufacturing the containers and/or reduces the energy costs as less water needs to be evaporated in the drying process. In addition, providing an amount of calcium carbonate and/or calcium bicarbonate enhances the strength and stiffness properties, and also improves the oxygen transfer rate (OTR) barrier properties and can smoothen the surface to improve printability, in mould labelling, decoration in general. Calcium carbonate and/or calcium bicarbonate can be provided as a so-called filler material to the matrix and/or can be used in combination with other materials.

In a presently preferred embodiment the amount of calcium carbonate and/or calcium bicarbonate is in the range of 0 wt % to 2 wt. % of the matrix of the moulded fiber product, more preferably in the range of 0.4 wt % to 1.2 wt %.

Preferably, the calcium carbonate is applied as filler material in combination with MFC in the matrix of the moulded fiber product. Preferably, the matrix comprises a mixture of MFC and calcium carbonate, more preferably with an amount of 5 wt % to 10 wt % of the matrix of the moulded fiber product. In this mixture the amount of calcium carbonate is in the range of 1 wt % to 12 wt % of the mixture, more preferably in the range of 2.5 wt % to 11 wt %, and most preferably in the range of 5 wt % to 10 wt %. This even further improves product properties, such as strengthening of the product, smoothening of the surface of the product, enhancing denestability, improving printability, and being less sensitive for swelling.

In a further preferred embodiment of the invention the plant-based fiber material of the moulded fiber product comprises an amount of non-wood fiber material.

The non-wood fiber material is also referred to as natural and/or alternative fibers. Providing an amount of these fibers in the matrix of the moulded fiber product provides a natural feel to the container and/or improves the overall strength and stability of the container. Such fibers may comprise fibers from different origin, specifically biomass fibers from plant origin.

This biomass of plant origin may involve plants from the order of Poales including grass, sugar cane, bamboo and cereals including barley and rice. Other examples of biomass of plant origin are plants of the order Solanales including tomato plants of which the leaves and/or stems could be used, for example plants from the Order Arecales including palm oil plants of which leaves could be used, for example plants from the Order Maphighiales including flax, plants from the Order of Rosales including hemp and ramie, plants from the Order of Malvales including cotton, kenaf and jute. Alternatively, or in addition, biomass of plant origin involves so-called herbaceous plants including, besides grass type plants and some of the aforementioned plants, also jute, Musa including banana, Amarantha, hemp, cannabis etc. In addition or as an alternative, biomass material origination from peat and/or moss can be applied.

In another preferred embodiment the (lignocellulosic) biomass of non-wood plant origin comprises biomass originating from plants of the Family of Poaceae (to which is also referred to as Gramineae). This family includes grass type of plants including grass and barley, maize, rice, wheat, oats, rye, reed grass, bamboo, sugar cane (of which residue from the sugar processing can be used that is also referred to as bagasse), maize (corn), sorghum, rape seed, other cereals, etc. Especially the use of so-called nature grass (defined by “Staatsbosbeheer” as grass clippings originating from natural landscape) provides good results when manufacturing containers. Such nature grass may originate from a natural landscape, for example. This family of plants has shown good manufacturing possibilities in combination with providing a sustainable product to the consumer. Optionally, the (lignocellulosic) biomass of non-wood plant origin comprises material from the coffee plant (Coffea) in the family Rubiaceae. Optionally, this biomass is used in combination with other biomass.

In a presently preferred embodiment the non-wood fiber material comprises material from one or more of soja fibers, rice husks, almond, and coconut shells.

Experiments showed that the use of these raw materials for the non-wood fiber material provides good results and contributes to the strength and stability of the container. Furthermore, the use of these products also contributes to the sustainability of the container. A further advantage is that the raw material can be chosen in relation to the actual dairy product in the container to provide a further association to the consumer of the container and dairy product.

In a presently preferred embodiment of the container the non-wood fiber material provides at least 5 wt % of the matrix of the product receiving body, preferably at least 10 wt %, preferably at least 50 wt %, even more preferably at least 80 wt %, even further more preferably at least 85 wt %, and most preferably at least 92.5 wt %. It was shown that containers can be manufactured effectively from the non-wood fiber material in such significant amounts.

In a presently preferred embodiment the matrix of the moulded fiber product comprises an amount of fibers, wherein at least 80 percent of the fibers has a length above 1.1 mm, preferably above 1.2 mm. This provides a significant length increase of the fibers that are provided in the moulded pulp material. This results in an increased strength-weight ratio for the modified atmosphere packaging units.

The invention further relates to a method for manufacturing a moulded fiber container for dairy products, the method comprising the steps of:
providing a moulded fiber container for dairy products in accordance to one of the embodiments of the invention;
filling the cup-like container body with the products; and
sealing the cup-like container body.

The method provides the same or similar effects as described in relation to the moulded fiber container. The coating can be provided to the moulded fiber product involving lamination, or spray-coating, airless spray coating, air driven pulsed spray coating, plasma coating, curtain coating, airless pulsed coating application, atomic deposition coating techniques, vacuum deposit coating techniques, co-extrusion coating techniques, 3D printing techniques. Especially the spray-coating avoid potential delamination issues.

The container can be provided using conventional wet forming techniques. In one of the presently preferred embodiments of the invention the container is provided using dry forming, preferably using so-called fluffy pulp. This fluffy pulp may comprise virgin and/or any suitable alternative fiber, for example. In this dry forming process, after cooking and disclosing the pulp, additives like oil sizing and/or water sizing and/or (biobased) binders can be added to the pulp on the paper machine. That pulp can be dried and supplied as sheets or reels. These reels or sheets can be fed into a hammer mill, or similar device, also known as defibrator, that separates compressed rolls or sheets of cellulose pulp into individual, loose fibers, which are then transported to the web forming system, involving up to 100% fiberization and minimal or zero nits. The fluffy pulp contains herewith already some barrier properties that are relevant for the 3D formed product to be provided. After the hammer mill and before the web forming (fluffy pulp blanket), the individual fibers can be sprayed/treated/mixed with dry binders or additional functional additives to support the 3D product properties like oxygen barrier, water vapour barrier, grease resistance, oil resistance and/or water resistance. The web can be formed (fluffy pulp blanket) and sprayed with additional functional coatings/additives. Then the web can optionally be sandwiched between thin layers of tissue paper to keep the web in place, avoiding that short fibers and dust particles contaminate the line and production environment and are lost. The production of fluffy pulp fibers, the addition of additives and/or the formation of the web are preferably performed in a controlled RH and temperature chamber to avoid fluctuations in moisture and avoid quality changes in the end products. The 3D moulded fiber products can be manufactured from the web in a tool in a press at pressing forces in the range of 100-500 ton/m² (equals 10-50 bar). The products will have so called embedded barrier properties. Optionally, the products can be post-processed. Such post-processing may involve applying a lamination film/barrier film, which can be a biobased, synthetic, natural biofilm. Alternatively, the 3D products can optionally be coated in a post-processing step with a biodegradable (bio) based coating or synthetic coating to meet the product quality, stiffness/strength, chilled conditions resistance and barrier properties for the specific application and to meet the customer needs.

The advantage of dry forming process and manufacture of 3D molded fiber products is that the energy consumption is only 20% to 35% in comparison with wet forming technology based moulded fiber production. The carbon footprint is therefore also only ⅕ or ⅓ compared to the wet forming technology. The production speed of the dry forming process is, depending on shape and format and complexity, a factor 2 to 7 higher as the wet forming and in-mould drying process. The investment in tooling and machinery for the dry forming process is considerably lower as well, making it very attractive for replacing plastic products by fiber based products using the dry forming technology.

The invention further also relates to the use of a moulded fiber container for dairy products according one of the embodiments or according to the invention.

Such use provides the same or similar effects as described in relation to the moulded fiber container and/or method for manufacturing such container.

Further advantages, features and details of the invention are elucidated on the basis of preferred embodiments thereof, wherein reference is made to the accompanying drawings, in which:

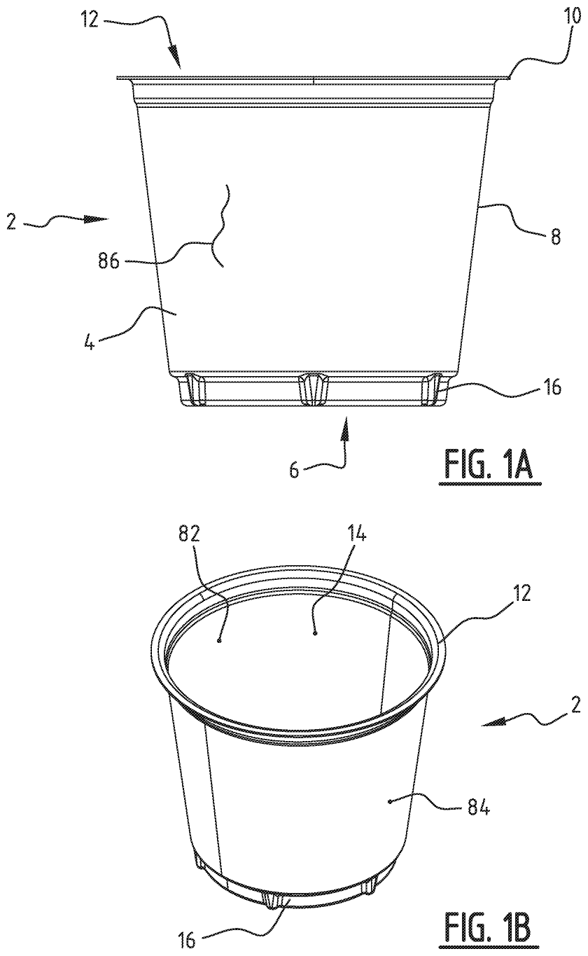

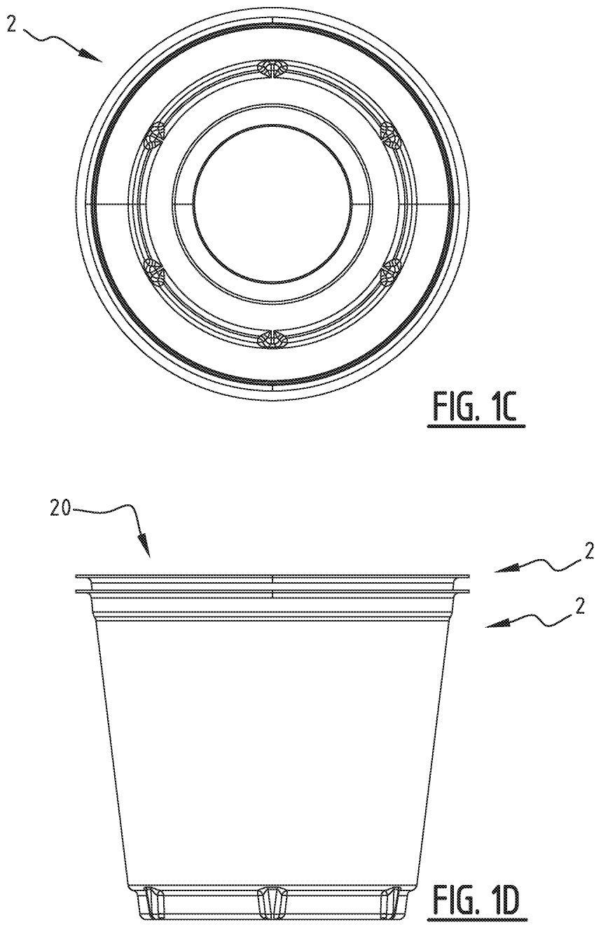

FIG. 1A-D shows a container for the dairy product according to the invention;

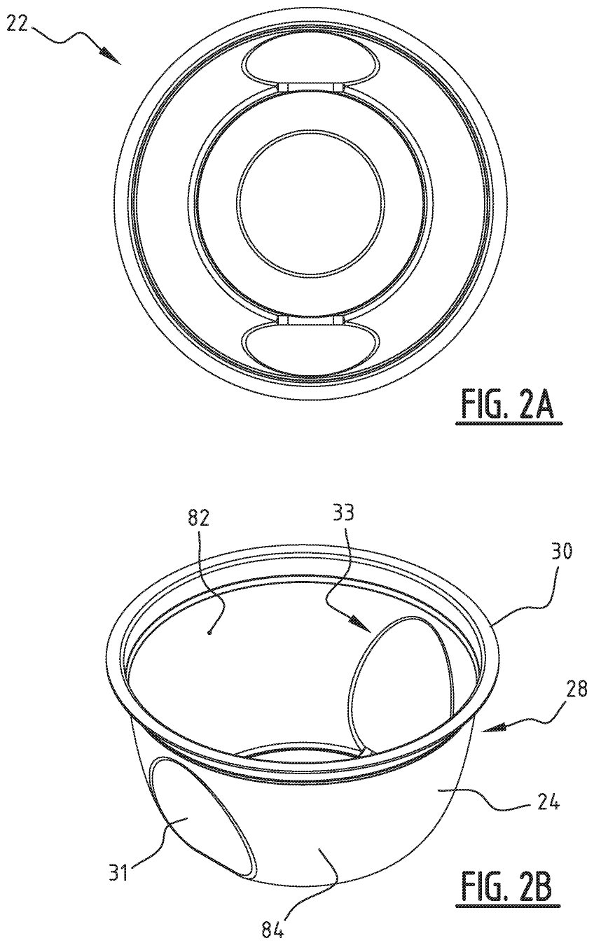

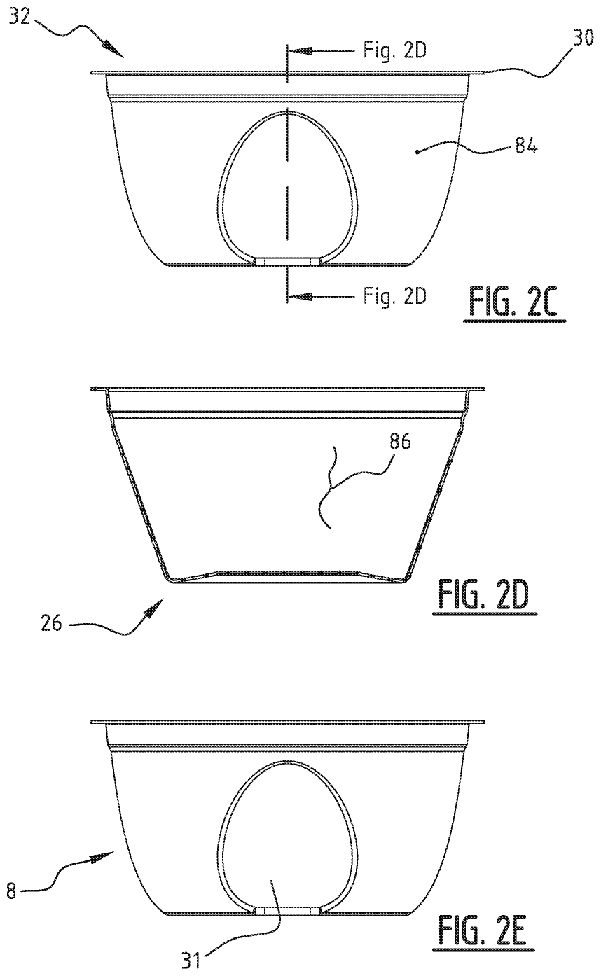

FIG. 2A-E shows a bow for a dairy product according to an alternative embodiment of the invention;

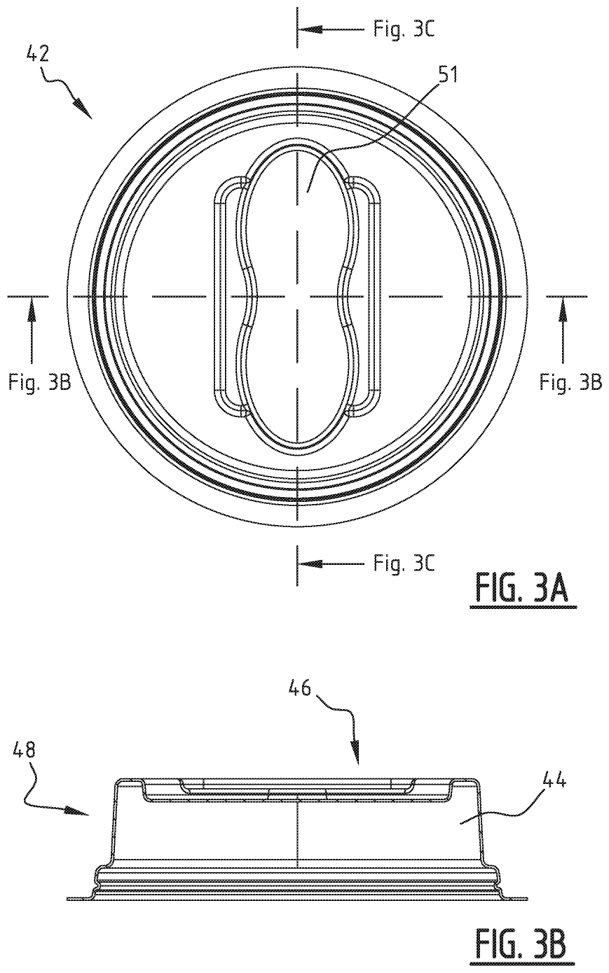

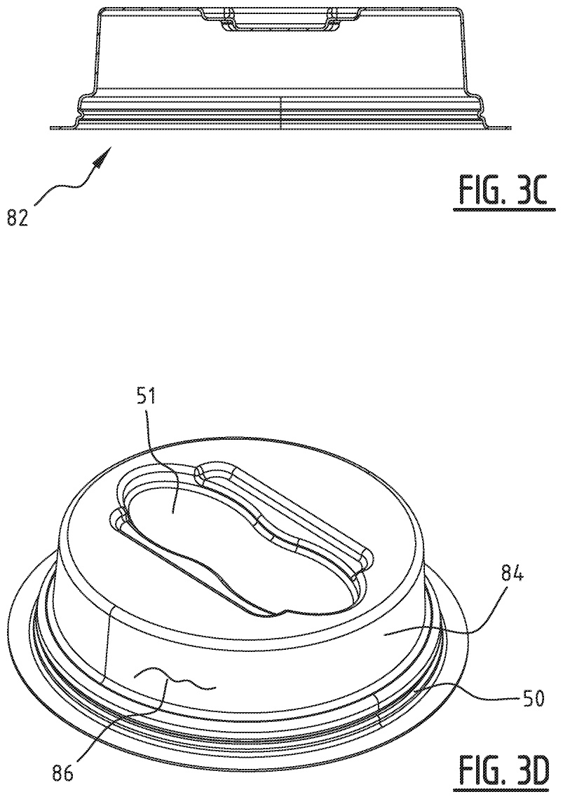

FIG. 3A-D shows a lid that can be applied to a container; and

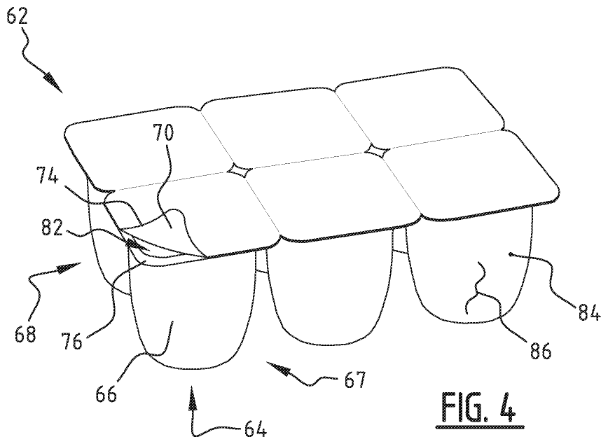

FIG. 4 shows a further alternative embodiment of a container for yoghurt according to the invention.

Container 2 (FIG. 1A-D) comprises cup-like container body 4 having bottom 6 and side wall 8. Flange 10 is configured for receiving seal 12 thereon. The inside of container 2 defines product compartment 14 (FIG. 1B). In the illustrated embodiment support 16 is provided to enable container 2 to stand firmly on a shelf or other container. Stack 20 (FIG. 1D) comprises a number of nested containers 2.

In an alternative embodiment of the invention bowl 22 (FIGS. 2A-E) is provided with cup-like container body 24, bottom 26 and side wall 28. Sealing lid 32 (FIG. 2C) is provided to flange 30. In the illustrated embodiment wall 28 is provided with label or embossing 31. In the illustrated embodiment bowl 22 is further provided with an indentation 33 that also acts as a denesting feature.

Moulded fiber lid 42 (FIGS. 3A-D) comprises top 46 having container body 44 and wall 48. Flange 50 is provided and is configured to connect to an upper flange of a bottom element (not shown). This bottom part may be similar to container 2 and/or bowl 22 wherein flange 50 connects to flange 10, 30. In the illustrated embodiment top 46 is provided with embossing or recess 51 enabling the provision of a spoon, for example.

Container 62 (FIG. 4) is configured for holding a yoghurt product and comprises bottom part 64 and side wall 66 that together define product receiving compartment 67 with opening 68. Before use, opening 68 is covered with sealing lid 70. In the illustrated embodiment sealing lid 70 comprises a paper layer that is provided with a coating that is similar to the inner and outer coatings illustrated for containers 2, 22, 42, 62. In this illustrated embodiment container 62 is provided with peelable sealing lid 70. Edge 74 of sealing lid 70 is peeled from edge 76 of container 62. Optionally, sealing lid 70 is provided as a transparent, non-transparent, semi-transparent or partly transparent sealing lid.

The inside of containers 2, 22, 42, 62 is provided with inner coating 82, while the outer surface is provided with outer coating 84. In some of the illustrated embodiments coatings 82, 84 are provided as a silicon-based coating that preferably comprises a silicon oxide, in particular a silicon dioxide. In some of the illustrated embodiments the sealing lid is also provided with the same coating. It will be understood that also different coatings and/or a combination of coatings can be envisaged in accordance with the present invention. For example, a coating of silane, graphene, chitosan, alginate, wax, polyethylene, silica gel can also be envisaged.

The illustrated moulded fiber product 2, 22, 42, 62 that is illustrated comprises a moulded fiber material that is provided with an amount of microfibrillated cellulose, and in addition an amount of biodegradable aliphatic polyester, such as PLA and/or PHBT. Optionally, an amount of calcium carbonate is applied. In one of these examples 3.8 wt % of MFC is applied in the moulded fiber product of the cup-like container body and flange, in combination with 3.7 wt % of biodegradable aliphatic polyester and in particular PHBT, and an amount of 1 wt % of calcium carbonate. Examples with and without the use of non-wood fiber material have been tested. In some of these examples an amount of soya fibers and/or rice husks and/or almond or coconut shells is applied in the plant-based fiber material. In such moulded fiber product fibers originating from wood are combined with an amount of about 48 wt % of alternative fibers. Preferably, an amount of alternative non-wood fiber material is included wherein the fibers remain visible on the old fiber product. This is illustrated with fibers 86 that are preferably present on the outer surface of container 2, 22, 42, 62.

It will be understood that other embodiments, dimensions and shapes of the container 2, 22, 42, 62 according to the present invention can be envisaged in accordance to the invention, optionally combining features of the illustrated embodiments to define a further embodiment of the invention.

A numbers of tests have been performed with different embodiments of container 2, 22, 42,62. These tests were performed with different amounts of MFC, and are provided with or without the use of additional chemicals, specifically Xerolex and/or AKD.

Tests were performed with several MFC types, including with Bang & Bonsomer/Betulium MFC, two type MFC25 and MFC65 (sugar beet residue based), and MFC from COSUN/Duynie (sugar beet residue based) and MFC from Graanul, Biotech in Estonia (wood based). Stiffness and strength improvements in tensile strength were measured, in RCT Ring crush compression test (important cardboard parameter), in burst index and tear strength resistance. The improvement effects at dosage levels of 2% MFC (as received. 8-20% dry matter, so 0.16-0.4% wt %) are in the range of 10-30% improvement. The possible increase in roughness (Bendsten) for the containers that comprise MFC as compared to the reference container could be compensated by applying calcium carbonate or clay as filler. In particular, an increase of 10-30% (in ml/min at 0.74 kPa) was measured.

The results show the applicability of the packaging unit as container for dairy products. The present invention is by no means limited to the above described preferred embodiments thereof. The rights sought are defined by the following claims, within the scope of which many modifications can be envisaged.

1. A moulded fiber container for dairy products, the container comprising:
a cup-like container body configured for holding an amount of a dairy product, and having a bottom part and wall part;
a flange configured for attaching a sealing lid thereon for closing the cup-like container body;
wherein the cup-like container body and the flange are a moulded fiber product,
wherein the inner surface of cup-like container body is provided with an inner barrier-coating, and
wherein the outer surface of cup-like container body is provided with an outer barrier-coating and/or in-mould paper label.

2. The moulded fiber container according to claim 1, wherein the inner and/or outer barrier-coating is a silicon based coating.

3. The moulded fiber container according to claim 2, wherein the silicon based coating comprises a silicon oxide and/or silane.

4. The moulded fiber container according to claim 1, wherein the inner and/or outer barrier-coating comprises an amount of graphene, chitosan, alginate, wax, polyethylene, or silica gel.

5. The moulded fiber container according to claim 1, wherein the moulded fiber product comprises an amount of plant-based fiber material, wherein at least a part of the amount is microfibrillated cellulose.

6. The moulded fiber container unit according to claim 5, wherein the amount of microfibrillated cellulose is in the range of 1.2 wt % to 10 wt % of the moulded fiber product.

7. The moulded fiber container according to claim 1, wherein the moulded fiber product comprises an amount of biodegradable aliphatic polyester.

8. The moulded fiber container according to claim 7, wherein the biodegradable aliphatic polyester comprises an amount of one or more of PBS, PHB, PHA, PCL, PLA, PGA, PBST, PBAT, PHBH, PBHT and PHBV.

9. The moulded fiber container according to claim 7, wherein the amount of biodegradable aliphatic polyester in the moulded fiber product is in the range of 0.5 wt % to 20 wt. %.

10. The moulded fiber container according to claim 7, wherein the amount of biodegradable aliphatic polyester in the moulded fiber product is in the range of 2 wt % to 10 wt. %.

11. The moulded fiber container according to claim 7, wherein the amount of biodegradable aliphatic polyester in the moulded fiber product is in the range of 0.1 wt % to 12 wt % of the unit.

12. The moulded fiber container according to claim 1, wherein the moulded fiber product comprises an amount of calcium carbonate and/or calcium bicarbonate.

13. The moulded fiber container according to claim 1, wherein the plant-based fiber material comprises an amount of non-wood fiber material.

14. The moulded fiber container according to claim 13, wherein the non-wood fiber material comprises material from one or more of soja fibers, rice husks, almond and coconut shells.

15. The moulded fiber container according to claim 13, wherein the amount of non-wood fiber material is at least 5 wt. %.

16. The moulded fiber container according to claim 1, wherein the moulded pulp material comprises an amount of fibers, wherein at least 80% of the fibers has a length above 1.1 mm.

17. A method for manufacturing a moulded fiber container, comprising the steps of:
providing a moulded fiber container for dairy products comprising:
a cup-like container body configured for holding an amount of a dairy product, and having a bottom part and wall part; and
a flange configured for attaching a sealing lid thereon for closing the cup-like container body;
wherein the cup-like container body and the flange are a moulded fiber product,
wherein the inner surface of cup-like container body is provided with an inner barrier-coating, and
wherein the outer surface of cup-like container body is provided with an outer barrier-coating and/or in-mould paper label, filling the cup-like container body with the product; and
sealing the cup-like container body.

18. The method according to claim 17, wherein the step of providing the container comprises dry forming using a dry fluffy pulp.

19. A method for using a moulded container for dairy products comprising:
a cup-like container body configured for holding an amount of a dairy product, and having a bottom part and wall part; and
a flange configured for attaching a sealing lid thereon for closing the cup-like container body,
wherein the cup-like container body and the flange are a moulded fiber product,
wherein the inner surface of cup-like container body is provided with an inner barrier-coating, and
wherein the outer surface of cup-like container body is provided with an outer barrier-coating and/or in-mould paper label.

20. The moulded fiber container according to claim 2, wherein the amount of biodegradable aliphatic polyester in the moulded fiber product is in the range of 6.5 wt. % to 20 wt. %.
